(19) United States
(12) Patent Application Publication
(10) Pub. No.: US 2009/0079928 A1
(43) Pub. Date: Mar. 26, 2009

(54) CELL FOR LIQUID CRYSTAL DISPLAY DEVICES AND METHOD OF MANUFACTURING SAME, AND METHOD OF MANUFACTURING LIQUID CRYSTAL DISPLAY DEVICE

(75) Inventors: Takeshi OHASHI, Kumamoto (JP); Hitoshi Koyama, Tokyo (JP); Hironori Fujimoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/233,918

(22) Filed: Sep. 19, 2008

(30) Foreign Application Priority Data
Sep. 21, 2007 (JP) 2007-245100
Nov. 16, 2007 (JP) 2007-297486

(51) Int. Cl. G02F 1/1339

(52) U.S. Cl. 349/156; 349/190

(57) ABSTRACT

To provide a method of manufacturing a cell for liquid crystal display devices having high quality and a high yield rate. In accordance with one aspect of the present invention, a method of manufacturing cells for liquid crystal display devices, the cells for liquid crystal display devices including multiple-partitioned liquid crystal display panels, the method includes a step for forming pillar-shaped spacers in the vicinity area of the periphery and in the liquid crystal display panel formation area of at least either one of a pair of mother substrates, and a step for sticking the pair of the mother substrates together such that the mother substrates oppose to each other, wherein formation patterns of the pillar-shaped spacers are different between in the liquid crystal display panel area and in the vicinity area of the periphery such that the opposing gap in the vicinity area of the periphery of the pair of the mother substrates are maintained.

### BACKGROUND OF THE INVENTION

1. Field of the Invention

The present invention relates to a cell for liquid crystal display devices and a method of manufacturing the same. Furthermore, the present invention also relates to a method of manufacturing a liquid crystal display device.

2. Description of the Related Art

In a liquid crystal display device, an array substrate such as a TFT element substrate on which thin film transistors, an alignment layer, and the like are stacked and a color filter substrate (opposed substrate) on which color filters, an alignment layer, and the like are stacked are superimposed with each other with a certain gap that is formed between the substrates using in-plane spacers. Then, liquid crystal is poured into the space that is formed between the pair of opposed substrates with a seal pattern formed on the periphery of the substrates. A polarizing plate is arranged on the non-opposing side of each of the array substrate and the color filter substrate.

Spherical spaces, pillar-shaped spacers, or the likes are used as the in-plane spacers. Since the technique using the pillar-shaped spacers can improve the contrast ratio by suppressing the light leak around the spacers, it can improve the display quality in comparison to the technique using spherical spacers. In addition, the use of the pillar-shaped spacers can prevent abnormal alignment which would be caused by the movement of the spacers, and thereby enabling an improvement in resistance to vibrations and shocks.

Japanese Unexamined Patent Application Publication No. 2002-277865 (Patent document 1) proposes a structure in which pillar-shaped spacers are arranged not only in the display areas but also in the frame areas, which are partitioned outside the display areas, in order to prevent display unevenness in the vicinity of the periphery of the panel. FIG. 12 shows a cross section of the liquid crystal display device described in Patent document 1. As shown in the figure, the liquid crystal display device 150 includes an array substrate 110, a color filter substrate 120, pillar-shaped spacers 105, and the like. Furthermore, the pillar-shaped spacers 105 are formed not only in the display area 140 but also in the frame areas 141, which are partitioned outside the display area.

Incidentally, a liquid crystal display device can be obtained in the following manufacturing process. Firstly, a plurality of array substrate portions are formed in an array in a first mother substrate, and a plurality of color filter substrate portions are formed in an array in a second mother substrate. Next, after sealing material is applied to the opposing surface of either the first mother substrate or the second mother substrate, the pair of the mother substrates is stuck together and the sealing material is cured so that the cell for liquid crystal display devices is manufactured. Then, a plurality of liquid crystal display panels are obtained by cutting off the obtained cell for liquid crystal display devices, and liquid crystal display devices are obtained by mounting polarizing plates, backlights, and the like to these liquid crystal display panels.

In recent years, demands for reductions both in thickness and in weight for liquid crystal display devices have been growing. As a result, techniques for reducing the thicknesses of liquid crystal display devices by grinding or etching on glass substrates that constitute first mother substrates or second mother substrates have been widely used. (For example, Japanese Unexamined Patent Application Publication No. 2001-33795 (Patent document 2)) In many cases, the grinding and the etching are carried out, after a first mother substrate and a second mother substrate are stuck together and the sealing material is cured, in order to reduce the thickness of the glass substrate. In such a process, care must be taken to ensure that the washing water, the etching solution, and the like that are used during the thinning process do not infiltrate into the inside of the liquid crystal display panel. Therefore, the thinning process is carried out after the periphery of the space formed between the pair of the mother substrates is sealed by a sealing means.

### SUMMARY OF THE INVENTION

However, there has been a problem that the curing process of the above-mentioned sealing material takes a lot of time to discharge the gas that is generated by the curing of the sealing material to the outside of the pair of mother substrates. Especially, in the case where an organic film is used for the insulating film or the like that constitutes the part of mother substrate, it requires a lot of time for the thermocompression bonding. In some cases, the gas is not completely discharged before the sealing material is cured. As a result, the opposing gap on the periphery of the liquid crystal display panel has occasionally become wider in comparison to that of the remaining areas of the liquid crystal display panel. The unevenness in the opposing gap within the liquid crystal display panel may lead to deterioration in the quality and reduction in the yield rate. Therefore, development of the technology that enables the swift and sufficient discharge of the gas that is generated in the process for curing the sealing material has been earnestly desired.

Furthermore, there are cases where the water and the etching solution that are used in the above-mentioned thinning treatment process infiltrate into the inside of the liquid crystal display panel, resulting in reduction in the yield rate and deterioration in the quality. Therefore, development of the technology that can prevent the infiltration of the water, the etching solution, and the like into the inside of the liquid crystal display panel in the thinning treatment process has been strongly desired.

The present invention has been made in view of the above-described background. One of the objects of the present invention is to provide a cell for liquid crystal display devices having high quality and a high yield rate and a method of manufacturing the same, and a method of manufacturing a liquid crystal display device.

In accordance with one aspect of the present invention, a method of manufacturing a cell for liquid crystal display devices, the cell for liquid crystal display devices including multiple-partitioned liquid crystal display panels, the method includes: a step for forming pillar-shaped spacers in the vicinity area of the periphery and in the liquid crystal display panel formation area of at least either one of a pair of mother substrates; and a step for sticking the pair of the mother substrates together such that the mother substrates oppose to each other; wherein formation patterns of the pillar-shaped spacers are different between in the liquid crystal display panel area and in the vicinity area of the periphery such that the opposing gap on the periphery of the pair of the mother substrates are maintained.

In accordance with another aspect of the present invention, a method of manufacturing liquid crystal display devices including liquid crystal display panels includes: a step for forming pillar-shaped spacers in the vicinity area of the periphery and in the liquid crystal display panel formation area of at least either one of a pair of mother substrates; a step for sticking the pair of the mother substrates together such that the mother substrates oppose to each other; and a step for obtaining the liquid crystal display panels by cutting off the pair of mother substrates; wherein formation patterns of the pillar-shaped spacers are different between in the liquid crystal display panel area and in the vicinity area of the periphery such that the opposing gap on the periphery of the pair of the mother substrates are maintained.

In accordance with a first aspect of the present invention, a cell for liquid crystal display devices including a multiple-partitioned liquid crystal display panel includes: pillar-shaped spacers to maintain a gap between a pair of mother substrates that are placed opposite to each other, the pillar-shaped spacers being arranged in the liquid crystal display panel area and in the vicinity area of the periphery of the space formed between the pair of mother substrates; wherein the density of the pillar-shaped spacers in the vicinity area of the periphery is lower than the density of the pillar-shaped spacers in the liquid crystal display panel.

In accordance with a second aspect of the present invention, a cell for liquid crystal display devices including a multiple-partitioned liquid crystal display panel includes: pillar-shaped spacers to maintain a gap between a pair of mother substrates that are placed opposite to each other, the pillar-shaped spacers being arranged in the liquid crystal display panel area and in the vicinity area of the periphery of the space formed between the pair of mother substrates; wherein the size of the pillar-shaped spacers in the vicinity area of the periphery of the mother substrates is smaller than the size of the pillar-shaped spacers in the liquid crystal display panel.

The present invention has an advantageous effect that it can provide a cell for liquid crystal display devices having high quality and a high yield rate and a method of manufacturing the same, and a method of manufacturing a liquid crystal display device.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1A is a schematic plane view showing the structure of a liquid crystal display device in accordance with a first embodiment of the present invention;

FIG. 1B is a cross section of the liquid crystal display device taken along the line Ib-Ib of FIG. 1;

FIG. 2 is a schematic plane view of the essential part of a cell for liquid crystal display devices in accordance with the first embodiment of the present invention;

FIG. 3 is an enlarged partial schematic plane view of a corner portion of a cell for liquid crystal display devices in accordance with the first embodiment of the present invention;

FIG. 4 is a flowchart illustrating a manufacturing process of liquid crystal display devices in accordance with the first embodiment of the present invention;

FIG. 5 is a graph in which the coating thicknesses of photosensitive resin used to form pillar-shaped spacers are plotted against distances from the edge of the substrate;

FIG. 6 is an enlarged partial schematic plane view of a corner portion of a cell for liquid crystal display devices in accordance with a second embodiment of the present invention;

FIG. 7 is an enlarged partial schematic plane view of a corner portion of a cell for liquid crystal display devices in accordance with a third embodiment of the present invention;

FIG. 8 is an enlarged partial schematic plane view of a corner portion of a cell for liquid crystal display devices in accordance with a fourth embodiment of the present invention;

FIG. 9 is an enlarged partial schematic plane view of a corner portion of a cell for liquid crystal display devices in accordance with a fifth embodiment of the present invention;

FIG. 10 is a schematic plane view of the essential part of a cell for liquid crystal display devices in accordance with a sixth embodiment of the present invention;

FIG. 11 is an enlarged partial schematic plane view of a corner portion of a cell for liquid crystal display devices in accordance with a sixth embodiment of the present invention;

FIG. 12 is a cross section showing the structure of a liquid crystal display device in the related art.

FIG. 13 is a cross section showing the structure of the edge portion of a cell for liquid crystal display devices in the related art.

### PREFERRED EMBODIMENT OF THE INVENTION

Embodiments to which the present invention is applied are explained hereinafter. Incidentally, it should be understood that other embodiments that are consistent with the gist of the present invention also fall within the scope of the present invention. Furthermore, the sizes and scales of components shown in the drawings are just for illustrative purpose, and other sizes and scales may be used in practical applications.

### First Embodiment

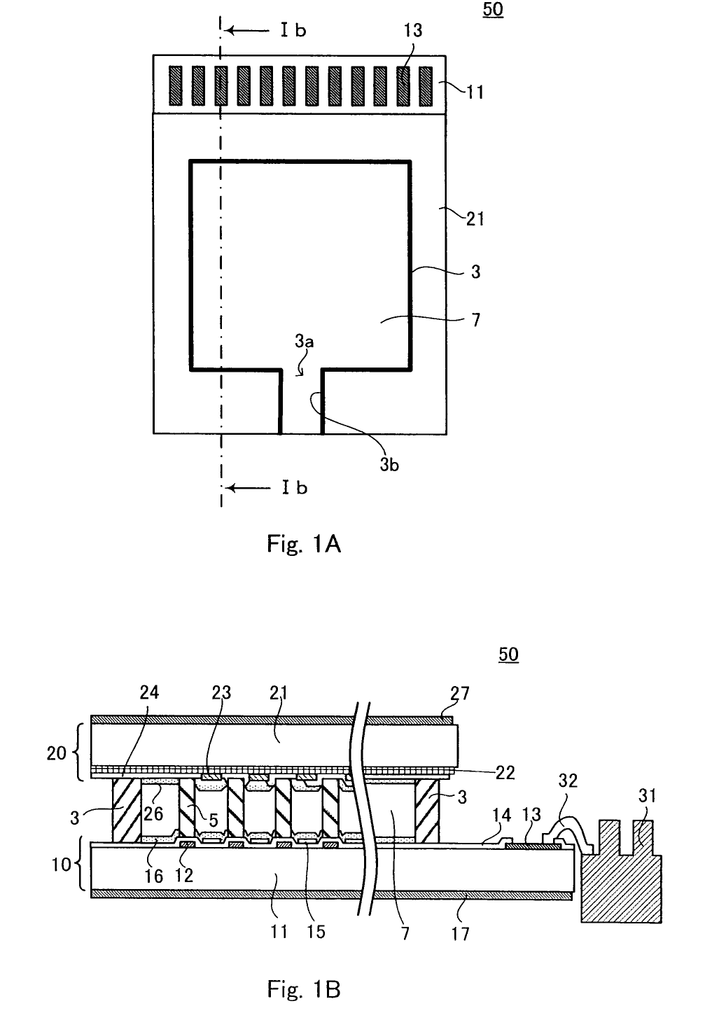

FIG. 1A shows a plane view of a liquid crystal display device 50 in accordance with a first embodiment of the present invention, and FIG. 1B shows a cross section of the liquid crystal display device taken along the line Ib-Ib of FIG. 1A. In the first embodiment, a TFT (Thin Film Transistor) type liquid crystal display device in which TFTs are used as switching elements is explained as an example.

As shown in FIG. 1B, the liquid crystal display device 50 includes an array substrate 10 and a color filter substrate 20, which is placed opposite to the array substrate 10, as a first substrate and a second substrate respectively. Furthermore, both the substrates are stuck together by a seal pattern formed on the periphery of the space formed between the pair of substrates, and the space between the substrates is filled with liquid crystal 7.

The array substrate 10 includes a first insulating substrate 11 composed of a light-transparent glass substrate. A first alignment layer 16 that is used to orientate the liquid crystal 7 is formed on the surface of the first insulating substrate 11 that opposes to the color filter substrate 20, and a first polarizing plate 17 is arranged on the main outer surface of the first insulating substrate 11. Pixel electrodes 15 for applying voltage to drive the liquid crystal 7, switching elements such as TFTs (not shown) for supplying voltage to the pixel electrodes 15, electrical lines 12 for supplying signals to the switching elements, and the likes are provided in layers below the first alignment layer 16. Furthermore, a insulating film 14 covering the switching elements and lines 12, terminal electrodes 13 for receiving external signals that are supplied to the switching elements, a transfer electrode (not shown) for transferring signals that are inputted from the terminal electrodes 13 to a common electrode 24 (which is explained later), and the like are also provided. As indicated by its name, the pixel electrodes 15 and the switching elements are arranged in an array on a pixel-by-pixel basis in the array substrate 10.

The color filter substrate 20 includes a second insulating substrate 21 composed of a light-transparent glass substrate. A second alignment layer 26 that is used to orientate the liquid crystal 7 is formed on the surface of the second insulating substrate 21 that opposes to the array substrate 10, and a second polarizing plate 27 is arranged on the main outer surface of the second insulating substrate 21. A common electrode 24 that drives the liquid crystal 7 by producing an electric field between the common electrode 24 and the pixel electrodes 15 formed over the array substrate 10 is provided in a layer below the second alignment layer 26. A color filter layer 23, a shielding layer 22, and the like are provided below the common electrode 24.

The common electrode 24 is configured so as to be electrically connected to the transfer electrode (not shown) arranged over the array substrate 10 through transfer material (not shown) formed between the array substrate 10 and the color filter substrate 20. Furthermore, they are configured such that external signals that are inputted from the terminal electrodes 13 are transferred to the common electrode 24 through the transfer electrode and the transfer material. In this manner, common electrical potential is supplied to the common electrode 24, so that the liquid crystal 7 is driven by the electric field produced between the pixel electrodes 15 and the common electrode 24.

An in-panel seal 3 is formed in the peripheral area of the space formed between the array substrate 10 and the color filter substrate 20 such that it surrounds the display area (see FIG. 1A). As shown in FIG. 1A, the in-panel seal 3 includes a liquid crystal filling port 3a that is used to pour liquid crystal (which is explained later with the explanation of the manufacturing process).

As shown in FIG. 1B, the array substrate 10 has a larger outer dimension than that of the color filter substrate 20, and the above-described terminal electrodes 13 are formed in the area of the array substrate 10 that does not oppose to the color filter substrate 20. The gap between the array substrate 10 and the color filter substrate 20 is maintained at a specified length by using in-plane spacers, i.e., pillar-shaped spacers 5.

The liquid crystal display device 50 also includes, in addition to the above-mentioned components, a control substrate 31 for generating various driving signals, a FFC (Flexible Flat Cable) for electrically connecting the control substrate 31 to the terminal electrodes 13, a backlight unit (not shown), and the like. The backlight unit is arranged on the non-viewable side of the liquid crystal display device 50 so that it illuminates the liquid crystal display panel from the back side.

Next, the operation of a liquid crystal display device 50 in accordance with the first embodiment of the present invention is explained hereinafter. For example, when electrical signals are inputted from the control substrate 31, various signals are supplied to the terminal electrodes 13 through the FFC 32. Then, a scanning signal and a display signal are supplied from the terminal electrodes 13 to the lines 12. In this manner, display voltages are applied to pixel electrodes 15 that are electrically connected to the lines 12. Furthermore, a signal that is inputted from the terminal electrodes 13 is transferred to the common electrode 24 through the transfer electrode and the transfer material, and common potential is supplied to the common electrode 24. In this manner, an electric field is produced between the pixel electrodes 15 and the common electrode 24.

The direction of the molecules of the liquid crystal is changed depending on the electric field between the pixel electrode 15 and the common electrode 24. Then, the light irradiated form the backlight unit is externally transmitted or shielded through the array substrate 10, the liquid crystal 7, and the color filter substrate 20, and therefore desired images or the like are displayed on the liquid crystal display device.

Incidentally, the structure of the above-described liquid crystal display device 50 is merely one example, and other structures may be used as substitutes. Furthermore, the operating mode of the liquid crystal display device 50 may be TN (Twisted Nematic) mode, STN (Super Twisted Nematic) mode, ferroelectricity liquid crystal mode, or the like. For the driving method, passive matrix, active matrix, or the like may be used. Furthermore, the present invention is also applicable to a liquid crystal display device using a transverse electric field mode in which the common electrode 24 is arranged on the array substrate 10 side instead of arranging over the color filter substrate 20 as in the case of FIG. 1B so that an electric field is produced in the transverse direction between the common electrode 24 and the pixel electrodes 15.

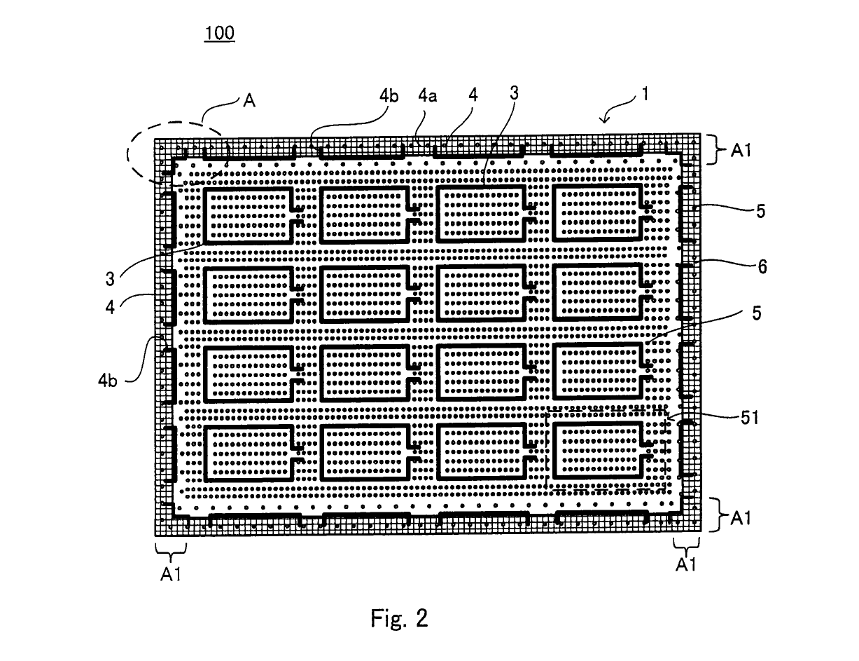

Next, a cell for liquid crystal display devices 100 in accordance with the first embodiment of the present invention is explained hereinafter. FIG. 2 is a schematic plane view of a cell for liquid crystal display devices 100 in accordance with the first embodiment of the present invention. The cell for liquid crystal display devices 100 includes a pair of substrates composed of a first mother substrate 1 and a second mother substrate 2. In the example shown in FIG. 2, only in-panel seals 3, peripheral seals 4, pillar-shaped spacers 5, and peripheral end-sealing material 6, as well as the first mother substrate 1, are illustrated for the sake of simplified explanations.

With the cell for liquid crystal display devices 100, a plurality of liquid crystal display panels are obtained by cutting off the first mother substrate 1 and the second mother substrate 2 in the cutting-off process (which is explained later). In the example shown in FIG. 2, an example where a 4×4 array of the liquid crystal display panels 51 is formed in the pair of rectangular mother substrates is illustrated. In FIG. 2, the area of which corresponds to one liquid crystal display panel 51 is illustrated with dotted lines for the sake of illustration. The peripheral seals 4 and the peripheral end-sealing material 6 cooperate to serve as a sealing means. In this manner, it can prevent the infiltration of the water and the etching solution in the thinning process of the first mother substrate 1 or/and the second mother substrate 2.

The peripheral seals 4 have openings 4a, which are used to discharge gas generated in the space between the pair of mother substrates in the seal curing process (which is explained later). In the first embodiment, seal patterns, each of which is roughly parallel to and has roughly the same length as the in-panel seal 3 of each liquid crystal display panel and includes guide portions 4b, which extend from both edges of the seal pattern and are roughly perpendicular to the nearest side of the second mother substrate 2, are provided as the peripheral seals 4 in the areas in the vicinity of each side of the second mother substrate 2 such that the seal patterns oppose to the corresponding in-panel seals 3 (see FIG. 2). The provision of the guide portions 4b can improve the strength of the seal patterns. Furthermore, since the openings 4a are provided in the vicinity of the liquid crystal display panel formation areas, it can easily discharge the gas generated during the seal curing process. Furthermore, since the peripheral seals 4 are arranged so as to oppose to the in-panel seals 3 as shown in FIG. 2, there is no need to sever the peripheral seals 4 in the cutting-off process of the cell for liquid crystal display devices 100 (which is explained later)

The space formed between the pair of mother substrates is sealed by the peripheral end-sealing material 6 on the entire circumference in the peripheral area of the mother substrates. Incidentally, the peripheral end-sealing material 6 does not necessarily need to be formed on the entire circumference in the substrate edge portion, provided that the infiltration of the water and the etching solution can be prevented in the thinning process. In other words, the peripheral end-sealing material 6 needs to close at least the openings 4a of the peripheral seals 4.

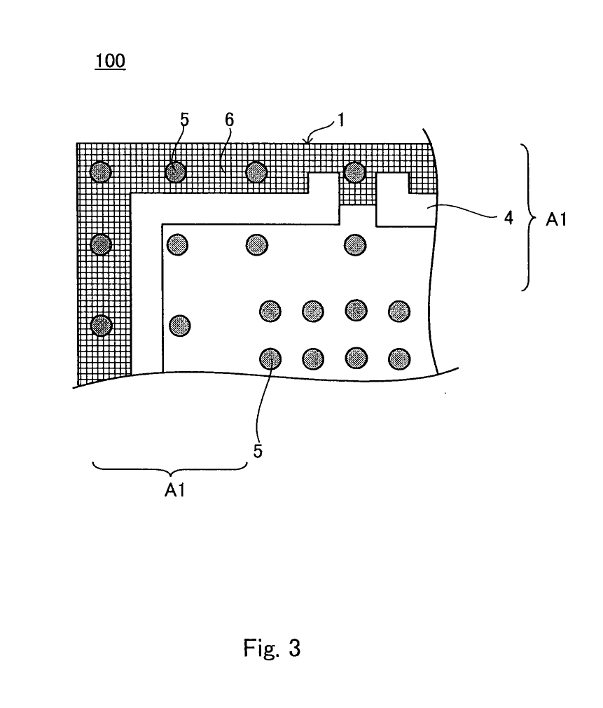

As shown in FIG. 2, the pillar-shaped spacers 5 are formed not only in the liquid crystal display panel formation areas but also in the vicinity area A1 of the periphery of the space formed between the pair of mother substrates in the first embodiment of the present invention. FIG. 3 is an enlarged partial plane view of the vicinity area of a corner portion of the pair of mother substrates (the area surrounded by the dotted line A in FIG. 2). As shown in the figure, pillar-shaped spacers 5 are formed such that the density of the pillar-shaped spacers 5 formed in the vicinity area A1 of the periphery of the mother substrates is lower than the density of the pillar-shaped spacers 5 formed in the non-vicinity area of the periphery including the liquid crystal display panel formation areas. The reason for this feature is explained later.

Incidentally, the peripheral seals 4, the peripheral end-sealing material 6, and the pillar-shaped spacers 5 formed in the vicinity Area A1 of the periphery are cut off from the liquid crystal display panels after the cutting-off process of the pair of mother substrates (which is explained later) and are not included in the end products.

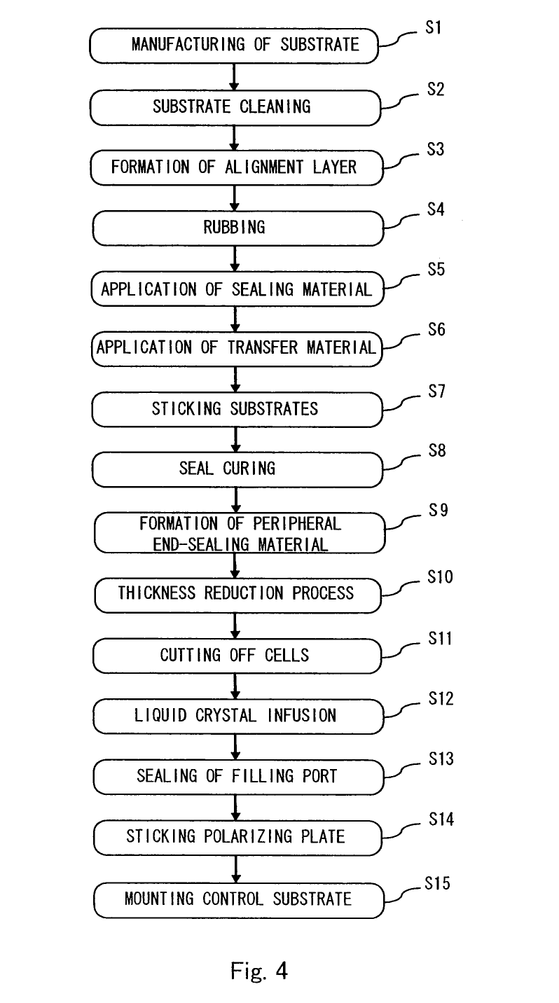

Next, a method of manufacturing cell for liquid crystal display devices 100 and liquid crystal display devices 50 in accordance with the first embodiment of the present invention is explained with reference to the flowchart shown in FIG. 4.

Firstly, a first mother substrate 1 having a plurality of array substrate portions and a second mother substrate 2 having a plurality of color filter substrate portions are manufactured. Incidentally, the first mother substrate 1 and the second mother substrate 2 correspond to the first insulating substrate 11 and the second insulating substrate 21 respectively of the above-described liquid crystal display device (see FIG. 1). The array substrate portions and the color filter substrate portions, both of which are formed on the mother substrates, will become the array substrates 10 and the color filter substrates 20 respectively in later processes. Since this process can be performed by using a typical manufacturing process, it is briefly explained hereinafter.

Firstly, a plurality of array substrate portions and a plurality of color filter substrate portions are produced on the first mother substrate 1 and the second mother substrate 2 respectively (step S1). Specifically, switching elements such as TFTs, electrical lines 12, terminal electrodes 13, an insulating film 14, pixel electrodes 15, and the like are formed on one of the main surfaces of the first mother substrate 1, which is composed of a glass substrate. Furthermore, a shielding layer 22, colored layers 23, common electrodes 24, and the like are formed into desired patterns on one of the main surfaces of the second mother substrate 2, which is composed of a glass substrate. These components can be obtained by carrying out film formation, patterning by photolithography, and etching, or similar process. The liquid crystal display panels may be arranged in an orderly fashion in parallel to the short sides and the long sides of the first and second mother substrates 1 and 2 so that a lot of the liquid crystal display devices 50 can be manufactured from the first and second mother substrates with efficiency.

Furthermore, pillar-shaped spacers 5 are formed in the second mother substrate 2 in the first embodiment of the present invention. As described above, the pillar-shaped spacers 5 are formed, in addition to in the area of each liquid crystal display panel 51, in the vicinity Area A1 of the periphery of the second mother substrate 2. However, the density of the pillar-shaped spacers in the vicinity Area A1 of the periphery of the second mother substrate 2 is lower than the density of the pillar-shaped spacers in the remaining areas. Publicly-known pillar-shaped spacers can be used for the pillar-shaped spacers 5. The use of photosensitive resin is preferable in terms of the simplicity of the manufacturing process. To form pillar-shaped spacers 5, photosensitive resin or the like is firstly applied by a spin coat method to form the coating of the photosensitive resin. Then, the pillar-shaped spacers 5 having desired shapes are formed with desired density through a photolithography process such as exposure, development, and the like.

In the first embodiment of the present invention, the pillar-shaped spacers 5 are arranged such that the density of the pillar-shaped spacers 5 in the area within 5 mm from the edge of the second mother substrate 2 is one quarter of the density of the pillar-shaped spacers 5 in the remaining internal areas. That is, the pillar-shaped spacers 5 are arranged such that the density of the pillar-shaped spacers 5 in the area within 5 mm from the edge of the second mother substrate 2 is one quarter of the density of the pillar-shaped spacers 5 that are typically formed in liquid crystal display panels. The typical shape and size for pillar-shaped spacers that are used in typical liquid crystal display panels are used as the shape and size of the pillar-shaped spacers 5.

Next, the first mother substrate 1, on which array substrate portions are formed, is cleaned in the substrate cleaning process (step S2). Then, a first alignment layer 16 is formed on the surface of the first mother substrate 1 on which the pixel electrodes 15 were formed in the alignment layer formation process (step S3). For example, the first alignment layer 16, which is composed of an organic film, is applied, by a printing process, and the coating is dried by a calcining process using a hot plate or the like. After that, the first alignment layer 16 is subjected to an alignment process by carrying out rubbing on the first alignment layer 16 in the rubbing process (step S4).

Similar processes to the processes from the step S2 to the step S4, i.e., substrate cleaning, the formation of second alignment layer 26, and rubbing process are also carried out for the second mother substrate 2. Incidentally, in the case of the second mother substrate 2, the second alignment layer 26 is formed on the surface on which the common electrode 24 was formed.

Next, an application process of sealing material for the in-panel seals 3 and the peripheral seals 4 is carried out on the opposing surface of either the first mother substrate 1 or the second mother substrate 2 by a screen printing apparatus in the sealing material application process (step S5). For example, thermosetting resin such as epoxy adhesive or ultraviolet curing resin may be used for the sealing material. Preferably, the peripheral seals 4 have guide portions that are used to discharge the gas accumulated within the liquid crystal display panels to the outside of the substrates in the seal curing process. Next, an application process of transfer material is carried out on the opposing surface of either the first mother substrate 1 or the second mother substrate 2 in the transfer material application process (step S6).

After that, the first mother substrate 1 and the second mother substrate 2 are stuck together in the sticking process (step S7). In this manner, the array substrate portions and the color filter substrate portions of their respective mother substrates are stuck together as shown in FIG. 2, and a plurality of liquid crystal display panels are formed in an array. Then, while the first mother substrate 1 and the second mother substrate 2 remain in the stuck state, the in-panel seals 3 and the peripheral seals 4 are completely cured in the seal curing process (step S8). This process may be carried out by applying heat to the sealing material or irradiating the sealing material with ultraviolet light depending on the type of the sealing material.

Next, while the first mother substrate 1 and the second mother substrate 2 remain in the stuck state, a peripheral end-sealing material 6 is formed so as to cover the entire circumference of the periphery of the space formed between both substrates (step S9). In this process, curable resin is applied to the entire lateral circumference of the gap formed between the pair of mother substrates as the end-sealing material while pressure is applied to the pair of mother substrates in the thickness direction. After that, by ceasing the application of the pressure to the pair of mother substrates, the curable resign is pulled into the vicinity area of the periphery of the gap formed between the pair of mother substrates. Then, the peripheral end-sealing material is formed on the entire circumference of the pair of mother substrates by irradiating the curable resin with light, and the space formed between the pair of mother substrates is sealed. In this manner, the guide portions 4b of the peripheral seals are closed. Incidentally, although an example where the peripheral seals 4 and the peripheral end-sealing material 6 are used as the sealing means for the pair of mother substrates is explained in the first embodiment, the present invention is not limited to the above-described configuration. Instead, other configurations that can prevent the infiltration of water, chemical solution, and the like into the inside of the liquid crystal display panels in the thinning process (which is explained later) is also within the scope of the present invention.

After the sealing patterns are formed on the periphery of the space formed between the pair of mother substrates, a glass thinning process is carried out on either the first mother substrate 1 or the second mother substrate 2, or both of the substrates (step S10). For this thinning process, physical grinding or chemical grinding using chemical solution may be chosen as appropriate. In either case, a cleaning with water is carried out after the thinning process. The cell for liquid crystal display devices are manufactured in this manner.

Next, the pair of mother substrates, which were stuck together, is divided into a plurality of individual cells (liquid crystal display panels) (step S11). In this cutting off process, the peripheral portions of the substrates that are unnecessary to the individual cells are cut off and removed. The pillar-shaped spacers 5 formed on the periphery of the substrates, the peripheral end-sealing material 6, and the peripheral seals 4 are also removed as unnecessary peripheral portions.

Then, liquid crystal 7 is poured into each of the individual cells from a liquid crystal filling port 3a in the liquid crystal infusion process (step S12). This process may be carried out by pouring the liquid crystal 7 from the liquid crystal filling port 3a by vacuum infusion. Furthermore, the liquid crystal filling port 3a is sealed with panel end-sealing material (not shown) in the sealing process (step S13). In this process, curable resin is applied to the liquid crystal filling port 3a as the panel end-sealing material while pressure is applied to the liquid crystal display cell in the thickness direction. After that, by ceasing the application of the pressure to the liquid crystal display cell, the curable resign is pulled into the liquid crystal filling port 3a. Then, the panel end-sealing material is formed by irradiating the curable resin with light. After that, a first polarizing plate 17 and a second polarizing plate 27 are stuck on the liquid crystal display cell in the polarizing plate sticking process (step S14). Then, a control substrate 31 is mounted on the liquid crystal display cell in the control substrate mounting process (step S15). The manufacture of liquid crystal display devices 50 are completed through these processes.

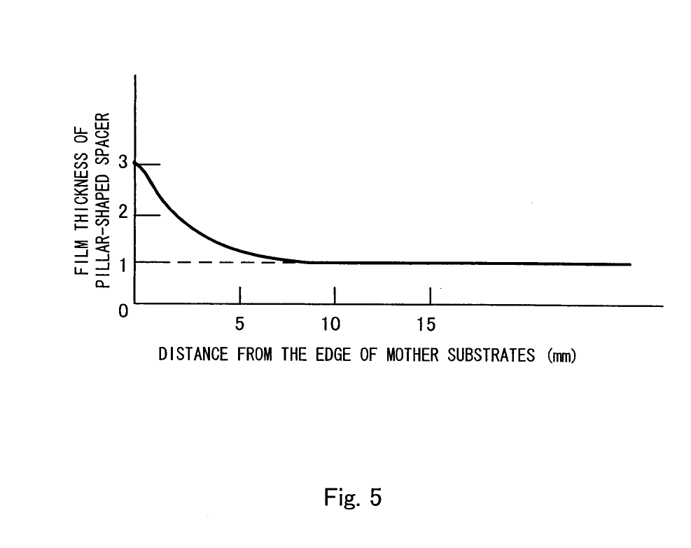

Next, the reason why the object of the present invention can be achieved with the aspect of the first embodiment is explained hereinafter. FIG. 5 is a graph in which the coating thicknesses of photosensitive resin that is applied to the second mother substrate to form pillar-shaped spacers are plotted against distances from the edge of the second mother substrate. Incidentally, the film thicknesses shown in the figure represent the values that are normalized by the mean film thickness within the substrate. As can be seen from the figure, the thickness in the vicinity Area A1 of the periphery within 5 mm from the substrate edge is two to three times thicker than that in the remaining non-vicinity area of the periphery. This is because the spin coat method is used for the application of the photosensitive resin. Therefore, no pillar-shaped spacers have been placed in the vicinity area A1 of the periphery of substrates in the prior art.

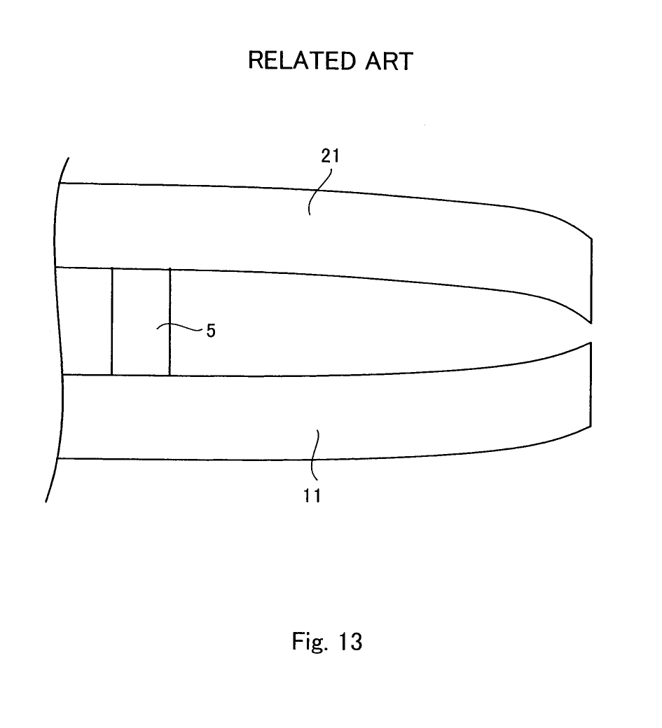

However, there have been cases where the gap between a pair of mother substrates becomes narrower in the edge portions of the substrates as shown in FIG. 13, resulting in defective sealing in the sealing process in which the periphery of the space formed between the mother substrates is sealed. As a result, the water, the etching solution, and the like are occasionally infiltrated into the inside of the liquid crystal display panel.

After the cumulative diligent studies by the inventors of the present application, we have found out that the opposing gap in the vicinity Area A1 of the periphery of the first mother substrate 1 and the second mother substrate 2 (gap between the pair of opposing substrates) can be kept from widening in comparison to that of the non-vicinity area of the periphery and can be adjusted to a desired length by arranging the pillar-shaped spacers 5 in the vicinity Area A1 of the periphery of the mother substrates and controlling the formation of the pillar-shaped spacers 5 such that the density of the pillar-shaped spacers 5 in the vicinity Area A1 of the periphery of the mother substrates is lower than the density of the pillar-shaped spacers in the remaining non-vicinity area of the periphery. As a result, it can prevent the opposing gap from becoming narrower in the vicinity Area A1 of the periphery of the gap between the first mother substrate 1 and the second mother substrate 2 as in the case shown in FIG. 13. Therefore, the peripheral end-sealing material 6 can be successfully pulled into the gap in the edge portion between the first mother substrate 1 and the second mother substrate 2 in the sealing process in which the periphery of the space formed between the mother substrates is sealed (step S9).

When the opposing gap in the vicinity of the periphery of the pair of mother substrates is narrow as shown in FIG. 13, it takes a longer time to sufficiently discharge the gas accumulated within the liquid crystal display panels to the outside of the substrates in the seal curing process. Especially, in the case where an organic film is used for the insulating film or the like that constitutes the part of mother substrate, it requires a longer time for the thermocompression bonding. In some cases, the gas is not completely discharged before the seal is cured, resulting in a wider opposing gap on the periphery of the liquid crystal display panel. In accordance with the first embodiment of the present invention, since pillar-shaped spacers 5 are provided in the vicinity area A1 of the periphery of the substrates and the peripheral seals 4 are equipped with the guide portions 4b, the gas that is generated during the seal curing can be discharged in a swift and sufficient manner.

In accordance with the first embodiment, since pillar-shaped spacers are also provided in the vicinity area A1 of the periphery of the space formed between the pair of mother substrates, it can prevent the opposing gap in the vicinity of the periphery of the pair of mother substrates from becoming narrower. Furthermore, in order to solve the problem that the coating thickness of the pillar-shaped spacers becomes thicker in the vicinity of the edge portion of the mother substrates, the density of the pillar-shaped spacers in the vicinity Area A1 of the periphery of the space formed between the mother substrates is reduced in comparison to that in the non-vicinity area of the periphery. Therefore, it can prevent the opposing gap between the mother substrates in the edge portions of the substrates from becoming wider than the opposing gap in the remaining areas. As a result, the present invention can provide a cell for liquid crystal display devices having high quality and a high yield rate and a method of manufacturing the same.

Specifically, since it can prevent the opposing gap in the vicinity of the periphery of the pair of mother substrates from becoming narrower, the gas that is generated in the seal curing process can be discharged in a swift and sufficient manner. Therefore, it can prevent the problem that the gas is not completely discharged before the seal is cured, resulting in a wider opposing gap on the periphery of the liquid crystal display panel in comparison to that in the remaining areas. Furthermore, since it can prevent the opposing gap in the vicinity of the periphery of the pair of mother substrates from becoming narrower, the peripheral end-sealing material can be easily pulled into the gap in the edge of the mother substrates before the thinning treatment process. As a result, it can prevent the defective formation of the peripheral end-sealing material so that the water, the chemical solution, and the like do not infiltrate into the inside of the liquid crystal display panel in the glass substrate thinning treatment process.

Moreover, since the pillar-shaped spacers in the vicinity Area A1 of the periphery of the mother substrates can be formed in the same formation process as the pillar-shaped spacers located within the liquid crystal display panel, it does not increase the number of manufacturing processes. Furthermore, since the glass substrate thinning process is carried out with a high yield rate after the first mother substrate 1 and the second mother substrate 2 are stuck together and before the stuck substrates are divided into a plurality of liquid crystal display panels, it can cut down on costs. Furthermore, since pillar-shaped spacers are used as the way of maintaining the gap between the first mother substrate 1 and the second mother substrate 2, it can achieve high display quality in comparison to the case where spherical spacers are used. Furthermore, when spherical spacers are used as the way of maintaining the gap between the first mother substrate 1 and the second mother substrate 2, the substrates are compressed inward and it has occasionally caused the unevenness in the opposing gap between the substrates in the thinning treatment process. The substitution of pillar-shaped spacers for the spherical spacers can solve this problem.

Incidentally, although an example where the pillar-shaped spacers 5 are formed on the second mother substrate 2 is explained in the first embodiment, the pillar-shaped spacers 5 may be formed on the first mother substrate 1 or on both of the substrates. Furthermore, an example where glass substrates are used as an example of the first mother substrate 1 and the second mother substrate 2 is explained, the present invention is applicable to other types of substrate such as polycarbonate substrates. Furthermore, although an example in which the vicinity area of periphery where the density of the pillar-shaped spacer arrangement is lower than that in the remaining areas is defined as the area within 5 mm from the substrate edge is explained in the first embodiment, the present invention is not limited to this exact feature. The area where the variation in the film thickness is significant can be varied depending on coating conditions, types of coating material, coating temperature, and the like for the spin coat. Therefore, the density of the pillar-shaped spacer arrangement may be adjusted as appropriate while defining the area where the variation in the coating thickness is significant as the vicinity area of periphery. Furthermore, the only requirement for the pillar-shaped spacers is that they should be formed at least in the liquid crystal display panel formation area and the vicinity Area A1 of the periphery.

### Second Embodiment

Next, an example of a cell for liquid crystal display devices having different patterns of pillar-shaped spacers from the above-described embodiment is explained hereinafter. Incidentally, the same signs are assigned to the same components as those in the above-described embodiment and explanations of them are omitted as appropriate in the following explanations.

The structure and the manufacturing method of a cell for liquid crystal display devices in accordance with a second embodiment are basically the same as those in the above-described first embodiment except for the following points. That is, the second embodiment differs from the first embodiment in that the density of the pillar-shaped spacers 5 is equal regardless of the locations where the pillar-shaped spacers 5 are formed in the second embodiment, whereas the density of the pillar-shaped spacers 5 in the vicinity area Al of the periphery of the pair of mother substrates is lower than that in the non-vicinity area of the periphery in the first embodiment. Furthermore, the second embodiment also differs from the first embodiment in that the size of the pillar-shaped spacers 5 in the vicinity Area A1 of the periphery of the pair of mother substrates is reduced in comparison to the size of the pillar-shaped spacers 5 in the non-vicinity area of the periphery in the second embodiment, whereas the size of the pillar-shaped spacers 5 is identical regardless of the locations where the pillar-shaped spacers 5 are formed in the first embodiment.

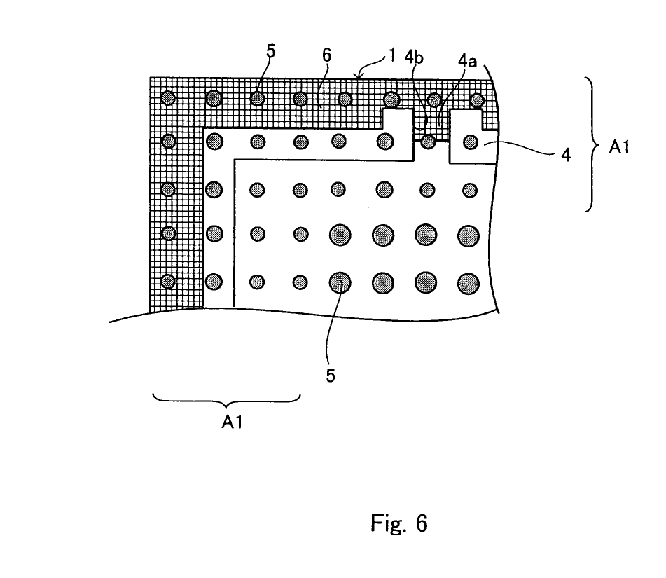

FIG. 6 is an enlarged partial schematic plane view of a corner portion of a cell for liquid crystal display devices in accordance with a second embodiment of the present invention. In the second embodiment, the diameter of the pillar-shaped spacers in the vicinity Area A1 of the periphery, i.e., the area within 5 mm from the edge of the second mother substrate 2 is adjusted to 0.7 times of the diameter of the pillar-shaped spacers in the non-vicinity area of the periphery.

In accordance with the second embodiment, since pillar-shaped spacers are also provided in the vicinity area Al of the periphery of the space formed between the pair of mother substrates, it can prevent the opposing gap in the vicinity of the periphery of the pair of mother substrates from becoming narrower. Furthermore, in order to solve the problem that the coating thickness of the pillar-shaped spacers becomes thicker in the vicinity of the edge portion of the mother substrates, the size of the pillar-shaped spacers in the vicinity Area A1 of the periphery of the space formed between the mother substrates is reduced in comparison to that in the non-vicinity area of the periphery. Therefore, it can prevent the opposing gap between the mother substrates in the edge portions of the substrates from becoming wider than the opposing gap in the remaining areas. As a result, the present invention can provide a cell for liquid crystal display devices having high quality and a high yield rate and a method of manufacturing the same.

Specifically, the gas that is generated during the seal curing process can be discharged in a swift and sufficient manner. Furthermore, it can prevent the defective formation of the peripheral end-sealing material 6 in the sealing process (step S9), so that the water, the chemical solution, and the like do not infiltrate into the inside of the liquid crystal display panel in the glass substrate thinning treatment process. As a result, it can provide a cell for liquid crystal display devices having a high yield rate and high reliability. Furthermore, since the number of the manufacturing processes is not increased as in the case of the above-described embodiment, it can cut down on costs.

### Third Embodiment

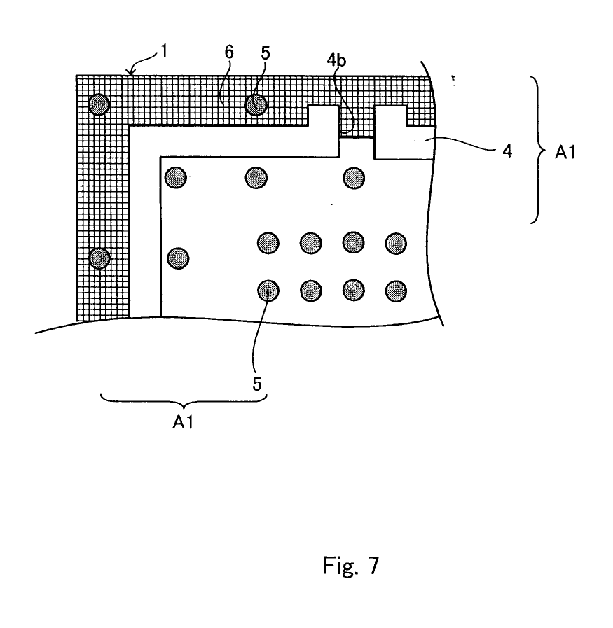

FIG. 7 is an enlarged partial schematic plane view of a corner portion of a cell for liquid crystal display devices in accordance with a third embodiment of the present invention. In the third embodiment, the pillar-shaped spacers are configured such that the density of the pillar-shaped spacers in the vicinity Area A1 of the periphery of the pair of mother substrates is changed in two steps. In this manner, the film thickness of the patterns formed by the pillar-shaped spacers can be more easily controlled. Specifically, the density of the pillar-shaped spacers 5 in the area between 3 mm to 5 mm from the edge of the pair of mother substrates is ¼ of the density of the pillar-shaped spacers 5 in the non-vicinity area of the periphery, and the density of the pillar-shaped spacers 5 in the area within 3 mm from the edge of the pair of mother substrates is ⅛ of the density of the pillar-shaped spacers 5 in the non-vicinity area of the periphery. In accordance with the third embodiment, it can achieve similar advantageous effects to those of the above-described embodiments.

### Fourth Embodiment

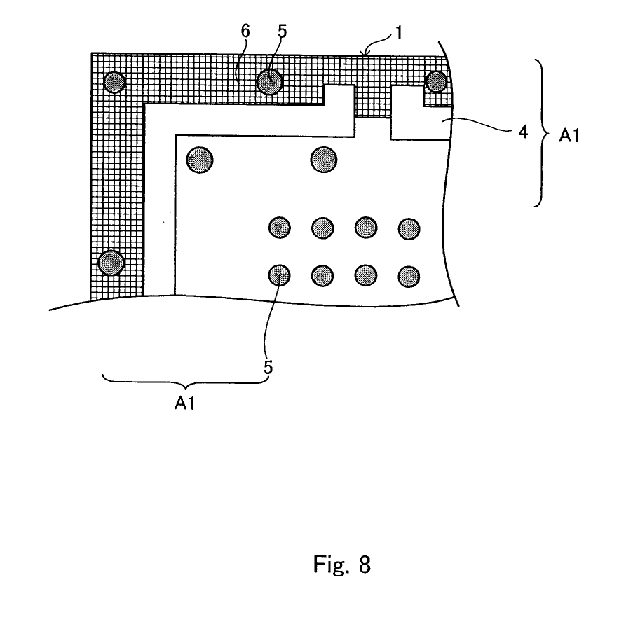

FIG. 8 is an enlarged partial schematic plane view of a corner portion of a cell for liquid crystal display devices in accordance with a fourth embodiment of the present invention. In the fourth embodiment, the outer diameter of pillar-shaped spacers is enlarged and the density of the pillar-shaped spacers is reduced in the vicinity area A1 of the periphery of the pair of mother substrates in comparison to the diameter and the density of the pillar-shaped spacers in the remaining non-vicinity area of the periphery. In this manner, it can prevent the peeling-off and the defective adhesion of the pillar-shaped spacers in the edge portions of the substrates. Although the diameter of pillar-shaped spacers in the edge portions of the substrates is enlarged, it can still achieve similar advantageous effects to those of the above-described embodiments because the density of the pillar-shaped spacers in the edge portions of the substrates is reduced.

### Fifth Embodiment

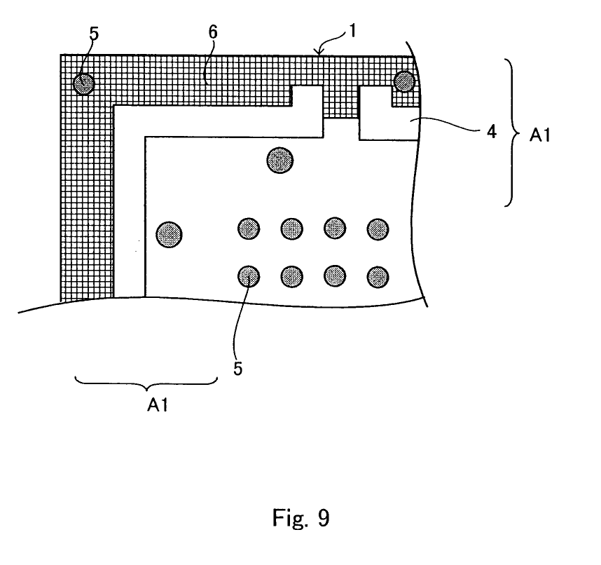

FIG. 9 is an enlarged partial schematic plane view of a corner portion of a cell for liquid crystal display devices in accordance with a fifth embodiment of the present invention. In the fifth embodiment, the density of the pillar-shaped spacers in the vicinity Area A1 of the periphery of the pair of mother substrates is changed in two steps, and the outer diameter of the pillar-shaped spacers in the vicinity area A1 of the periphery is enlarged in comparison to that in the non-vicinity area of the periphery as in the case of the above-described fourth embodiment. Specifically, the density of the pillar-shaped spacers 5 in the area between 3 mm to 5 mm from the edge of the pair of mother substrates is ⅛ of the density of the pillar-shaped spacers 5 in the non-vicinity area of the periphery, and the density of the pillar-shaped spacers 5 in the area within 3 mm from the edge of the pair of mother substrates is 1/16 of the density of the pillar-shaped spacers 5 in the non-vicinity area of the periphery. Furthermore, the outer diameter of the pillar-shaped spacers in the area within 5 mm from the substrate edge is enlarged by 30% in comparison to the outer diameter of the pillar-shaped spacers in the remaining non-vicinity area of the periphery. In accordance with the fifth embodiment, it can achieve similar advantageous effects to those of the above-described embodiments.

### Sixth Embodiment

Next, an example of a cell for liquid crystal display devices for which the thinning process is not carried out in the manufacturing process of the cell for liquid crystal display devices is explained hereinafter. The structure and the manufacturing method of a cell for liquid crystal display devices in accordance with a sixth embodiment are basically the same as those in the above-described first embodiment except for the following points. That is, the sixth embodiment differs from the first embodiment in that the peripheral seals and the peripheral end-sealing material are not provided in a cell for liquid crystal display devices in accordance with the sixth embodiment, whereas the peripheral seals 4 and the peripheral end-sealing material 6 are provided on the periphery of a cell for liquid crystal display devices in accordance with the first embodiment.

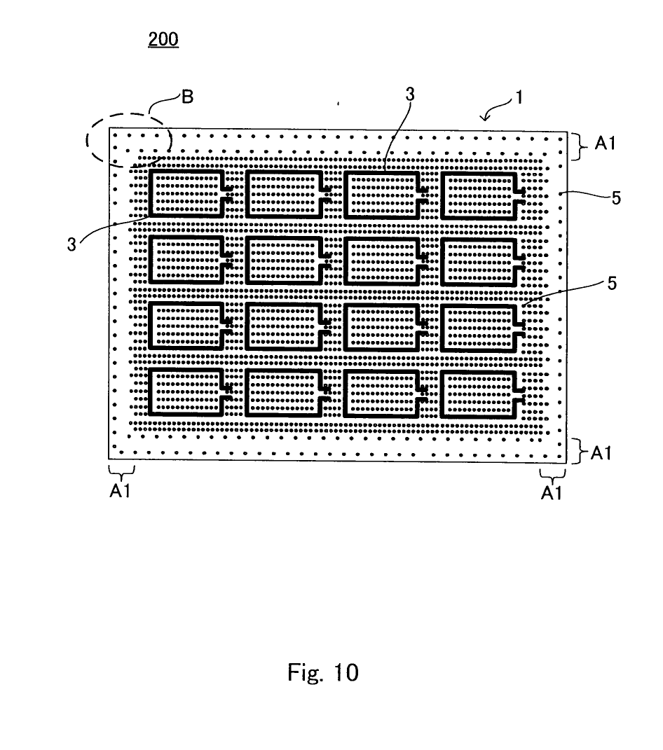

FIG. 10 is a schematic plane view of cell for liquid crystal display devices in accordance with a sixth embodiment of the present invention. In contrast to the above-described first embodiment, no peripheral seals 4 are formed on the substrates, and the first mother substrate 1 and the second mother substrate 2 are stuck together by the in-panel seals 3. Furthermore, the peripheral end-sealing material 6, which would otherwise serve as the sealing means with the peripheral seals 4, is also not formed on the substrates. Meanwhile, the pillar-shaped spacers 5, which have similar shape and size to those in the first embodiment, are arranged in similar positions to those in the first embodiment, and maintain the gap between the first mother substrate 1 and the second mother substrate 2. That is, the pillar-shaped spacers 5 are formed not only in the liquid crystal display panel formation area but also in the vicinity Area A1 of the periphery of the space formed between the pair of mother substrates.

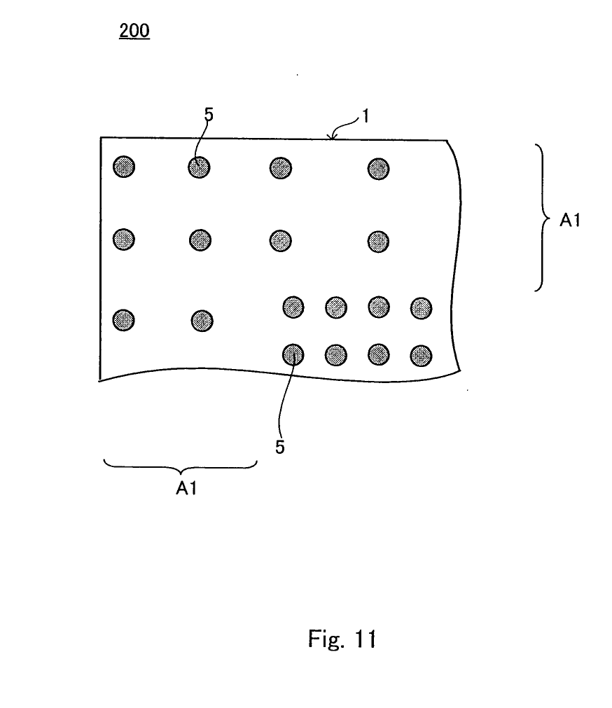

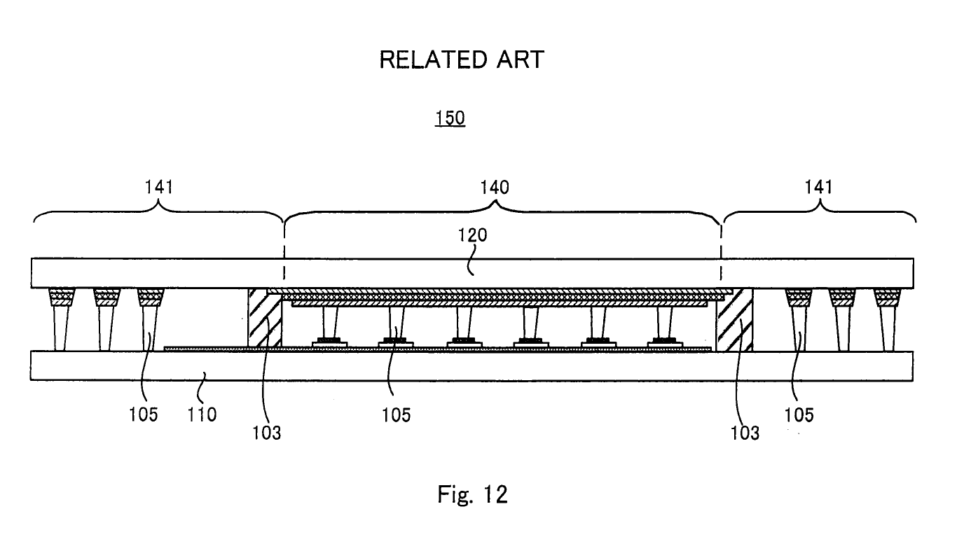

FIG. 11 is an enlarged partial schematic plane view of the vicinity area of a corner portion of the pair of mother substrates (the area surrounded by the dotted line B in FIG. 10). As shown in the figure, pillar-shaped spacers 5 are formed such that the density of the pillar-shaped spacers 5 formed in the vicinity area A1 of the periphery of the mother substrates is lower than the density of the pillar-shaped spacers 5 formed in the non-vicinity area of the periphery including the liquid crystal display panel formation area as in the case of the above-described first embodiment.

A method of manufacturing cell for liquid crystal display devices 200 and liquid crystal display devices 50 in accordance with the sixth embodiment of the present invention is explained hereinafter. Firstly, the processes of the steps S1-S8 are carried out as in the case of the above-described first embodiment (see FIG. 4). However, the application of the peripheral seals 4 is not carried out in the sealing material application process of the step S5 in contrast to the above-described first embodiment. That is, only the in-panel seals 3 are applied. As a result, the areas of the in-panel seals 3 are cured in the seal curing process of the step S8. After the seal curing of the step S8, the steps S11-S15 are carried out as the subsequent steps without carrying out the peripheral end-sealing material formation process of the step S9 and the thinning treatment process of the step S10. Since the detail of each of these steps is similar to its respective step in the first embodiment, explanations of them are omitted.

In accordance with the sixth embodiment, since pillar-shaped spacers are also provided in the vicinity area A1 of the periphery of the space formed between the pair of mother substrates, it can prevent the opposing gap in the vicinity of the periphery of the pair of mother substrates from becoming narrower. Furthermore, in order to solve the problem that the coating thickness of the pillar-shaped spacers becomes thicker in the vicinity of the edge portion of the mother substrates, the density of the pillar-shaped spacers in the vicinity Area A1 of the periphery of the space formed between the mother substrates is reduced in comparison to that in the non-vicinity area of the periphery. Therefore, it can prevent the opposing gap between the mother substrates in the edge portions of the substrates from becoming wider than the opposing gap in the remaining areas. As a result, the present invention can provide a cell for liquid crystal display devices having high quality and a high yield rate and a method of manufacturing the same.

Specifically, since it can maintain the opposing gap in the vicinity of the periphery of the pair of mother substrates in an appropriate manner, the gas that is generated during the seal curing process can be discharged in a swift and sufficient manner. Therefore, it can prevent the problem that the gas is not completely discharged before the seal is cured, resulting in a wider opposing gap on the periphery of the liquid crystal display panel in comparison to that in the remaining areas.

Moreover, since the peripheral seal is not arranged on the substrates in the sixth embodiment, the gas that is generated during the seal curing can be discharged to the outside of the substrates in a more efficient manner in the seal curing process (step S8). That is, the seal curing process can be carried out in a swifter and more efficient manner. Furthermore, the number of processes can be reduced by two in the manufacturing process in accordance with the sixth embodiment in comparison to the above-described first embodiment. As a result, it can cut down on costs. Furthermore, it can further cut down on costs in view of the fact that the peripheral sealing material and the peripheral end-sealing material are unnecessary. The reduction in thickness is not necessarily required depending on the application. Furthermore, lowering costs can be given a higher priority to the thickness reduction. The sixth embodiment is preferably applied in such cases.

Incidentally, even in the case where the thinning process is not carried out, the peripheral seals having openings may be arranged on the substrates for the consideration that they give mechanical strength or similar advantageous effects.

Incidentally, although the pillar-shaped spacers are arranged in the vicinity areas of the periphery located in the four sides of the pair of mother substrates in the above-described first to sixth embodiments, the present invention is not limited to these arrangements. For example, the pillar-shaped spacers may be arranged in the vicinity areas of the periphery that are located only in the short sides or only in the long sides. Furthermore, the present invention is also applicable to such a case that the pillar-shaped spacers can be formed only in one side(s) of the pair of mother substrates owing to the flow-direction in the substrate manufacturing process or similar conditions. Even in such a case, it can still achieve advantageous effects similar to the above-described advantageous effects.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of manufacturing a cell for liquid crystal display devices, the cell for liquid crystal display devices including multiple-partitioned liquid crystal display panels, the method comprising:
a step for forming pillar-shaped spacers in the vicinity area of the periphery and in the liquid crystal display panel formation area of at least either one of a pair of mother substrates; and
a step for sticking the pair of the mother substrates together such that the mother substrates oppose to each other;
wherein formation patterns of the pillar-shaped spacers are different between in the liquid crystal display panel area and in the vicinity area of the periphery such that the opposing gap on the periphery of the pair of the mother substrates are maintained.

2. A method of manufacturing liquid crystal display devices including liquid crystal display panels comprising:
a step for forming pillar-shaped spacers in the vicinity area of the periphery and in the liquid crystal display panel formation area of at least either one of a pair of mother substrates;
a step for sticking the pair of the mother substrates together such that the mother substrates oppose to each other; and
a step for obtaining the liquid crystal display panels by cutting off the pair of mother substrates;
wherein formation patterns of the pillar-shaped spacers are different between in the liquid crystal display panel area and in the vicinity area of the periphery such that the opposing gap on the periphery of the pair of the mother substrates are maintained.

3. The method of manufacturing liquid crystal display devices according to claim 2,
wherein the pillar-shaped spacers are formed such that the density or/and the pattern size of the pillar-shaped spacer arrangement is different between in the vicinity area of the periphery and in the liquid crystal display panel areas.

4. The method of manufacturing liquid crystal display devices according to claim 2, further comprising:
a step for sealing the periphery of the pair of mother substrates; and
a step for reducing the thickness of at least either one of the pair of mother substrates.

5. The method of manufacturing liquid crystal display devices according to claim 3, further comprising:
a step for sealing the periphery of the pair of mother substrates; and
a step for reducing the thickness of at least either one of the pair of mother substrates.

6. A cell for liquid crystal display devices including a multiple-partitioned liquid crystal display panel comprising:
pillar-shaped spacers to maintain a gap between a pair of mother substrates that are placed opposite to each other, the pillar-shaped spacers being arranged in the liquid crystal display panel area and in the vicinity area of the periphery of the space formed between the pair of mother substrates;
wherein the density of the pillar-shaped spacers in the vicinity area of the periphery is lower than the density of the pillar-shaped spacers in the liquid crystal display panel area.

7. A cell for liquid crystal display devices including a multiple-partitioned liquid crystal display panel comprising:
pillar-shaped spacers to maintain a gap between a pair of mother substrates that are placed opposite to each other, the pillar-shaped spacers being arranged in the liquid crystal display panel area and in the vicinity area of the periphery of the space formed between the pair of mother substrates;
wherein the size of the pillar-shaped spacers in the vicinity area of the periphery of the mother substrates is smaller than the size of the pillar-shaped spacers in the liquid crystal display panel area.

8. The cell for liquid crystal display devices according to claim 6, wherein the size of the pillar-shaped spacers in the vicinity area of the periphery of is larger than the size of the pillar-shaped spacers in the liquid crystal display panel area.

9. The cell for liquid crystal display devices according to claim 6, wherein:
the periphery of the pair of mother substrates is sealed by sealing means; and
the sealing means includes peripheral seals having openings, and peripheral end-sealing material closing at least the opening portions of the peripheral seals on the periphery of the space formed between the pair of mother substrates.

10. The cell for liquid crystal display devices according to claim 7, wherein:
the periphery of the pair of mother substrates is sealed by sealing means; and
the sealing means includes peripheral seals having openings, and peripheral end-sealing material closing at least the opening portions of the peripheral seals on the periphery of the space formed between the pair of mother substrates.

11. The cell for liquid crystal display devices according to claim 8, wherein:
the periphery of the pair of mother substrates is sealed by sealing means; and
the sealing means includes peripheral seals having openings, and peripheral end-sealing material closing at least the opening portions of the peripheral seals on the periphery of the space formed between the pair of mother substrates.
